(19) United States
(12) Patent Application Publication
(10) Pub. No.: US 2026/0138376 A1
(43) Pub. Date: May 21, 2026

(54) LIQUID EJECTING HEAD AND LIQUID EJECTING APPARATUS

(71) Applicant: CANON KABUSHIKI KAISHA, Tokyo (JP)

(72) Inventor: KYOSUKE TODA, Kanagawa (JP)

(21) Appl. No.: 19/383,207

(22) Filed: Nov. 7, 2025

(30) Foreign Application Priority Data
Nov. 19, 2024 (JP) 2024-201922

(51) Int. Cl. B41J 2/20; B41J 2/14; B41J 2/19; B41J 25/00

(52) U.S. Cl. CPC B41J 2/20; B41J 2/14145; B41J 2/14201; B41J 2/19; B41J 25/001; B41J 2002/14306; B41J 2002/14419

(57) ABSTRACT

A liquid ejecting head includes ejection orifice rows each configured as an array comprised of ejection orifices; pressure compartments where pressure acts on liquid to be ejected from the ejection orifices; common supply channels extending in an array direction of the ejection orifice row and configured to supply the liquid to the pressure compartments; common collection channels extending in the array direction of the ejection orifice row and configured to collect the liquid from the pressure compartments; a distributing channel that distributes the liquid to the common supply channels; a merging channel that merges the liquid from the common collection channels; a circulation pump that circulates the liquid in the order of the distributing channel, the common supply channel, the pressure compartment, the common collection channel, and the merging channel; and a bypass opening for connection between the common supply channel and the merging channel, not through the pressure compartment.

### BACKGROUND

### Field of the Technology

The present disclosure relates to a liquid ejecting head and a liquid ejecting apparatus.

### Description of the Related Art

A liquid ejecting apparatus is equipped with a liquid ejecting head for ejecting liquid, and achieves a desired purpose by ejecting the liquid from the liquid ejecting head. For example, in an inkjet recording apparatus, an inkjet recording head, which is a liquid ejecting head, is mounted on a carriage, and ejects ink from an ejection element substrate provided in the inkjet recording head, thereby recording an image, characters, or the like on a recording medium, which is the target of recording. During the recording of an image, characters, or the like, ejection orifices for ejecting the liquid from the liquid ejecting head are exposed to ambient air. For this reason, there is a risk of an increase in viscosity of the liquid inside pressure compartments, which are located near the ejection orifices and apply pressure to the liquid that is to be ejected from the ejection orifices, resulting in poor ejection.

Japanese Patent Laid-Open No. 2023-90627 discloses a liquid ejecting head provided with a circulation pump for circulating liquid. Inside this liquid ejecting head, the liquid is continuously circulated, thereby suppressing an increase in viscosity of the liquid near the pressure compartments. In such a configuration, since the liquid circulates inside the liquid ejecting head without going by way of the liquid ejecting apparatus, a channel for collecting the liquid from the liquid ejecting head to the liquid ejecting apparatus is unnecessary, making it possible to reduce the size of the liquid ejecting apparatus. Furthermore, compared with a case where the liquid is circulated between the liquid ejecting apparatus and the liquid ejecting head, circulation inside the liquid ejecting head alone shortens the path of circulation; therefore, the circulation pump to be mounted can also be made smaller, making it possible to suppress an increase in the size of the liquid ejecting head equipped with the circulation pump.

However, in the liquid ejecting head disclosed in Japanese Patent Laid-Open No. 2023-90627, since the circulation pump provided in the liquid ejecting head is small, its liquid-sending capability is low, and an air bubble easily stagnates in the channel near the pressure compartment. When an air bubble is present near the pressure compartment, the air bubble may be entrained into the pressure compartment during the process of ejection of the liquid, resulting in poor ejection. To suppress this, it has been known to provide a degassing module in the liquid ejecting head or the body of the liquid ejecting apparatus to perform degassing; however, if such a degassing module is provided, the liquid ejecting head or the liquid ejecting apparatus becomes larger.

### SUMMARY

The present disclosure provides a liquid ejecting head and a liquid ejecting apparatus that reduce the risk of an air bubble stagnating in a channel near a pressure compartment without increasing the size of the liquid ejecting head and the liquid ejecting apparatus.

A liquid ejecting head according to some embodiments of the present disclosure includes a plurality of ejection orifice rows each configured as an array comprised of a plurality of ejection orifices for ejecting liquid; a plurality of pressure compartments where pressure acts on the liquid that is to be ejected from the plurality of ejection orifices; a plurality of common supply channels extending in an array direction of the ejection orifice row and configured to supply the liquid to the plurality of pressure compartments; a plurality of common collection channels extending in the array direction of the ejection orifice row and configured to collect the liquid from the plurality of pressure compartments; a distributing channel configured to distribute the liquid to the plurality of common supply channels; a merging channel configured to merge the liquid from the plurality of common collection channels; a circulation pump configured to circulate the liquid in an order of the distributing channel, the common supply channel, the pressure compartment, the common collection channel, and the merging channel; and a bypass opening for connection between the common supply channel and the merging channel without going through the pressure compartment.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective view of a liquid ejecting apparatus.

FIG. 2 is a perspective view of a liquid ejecting head.

FIG. 3 is an exploded perspective view of a liquid ejecting head.

FIG. 4 is a schematic diagram illustrating ink circulation in a liquid ejecting apparatus.

FIG. 5 is a side view of a liquid ejecting head.

FIG. 6A is a cross-sectional view of a liquid ejecting head.

FIG. 6B is an enlarged cross-sectional view of the liquid ejecting head.

FIG. 7 is an enlarged cross-sectional view of the neighborhood of a pressure regulation mechanism.

FIG. 8 is a perspective view of a cover plate and an ejection element substrate.

FIG. 9 is a schematic diagram illustrating a connection relationship between an ejection element substrate and a head casing unit.

FIG. 10A is a cross-sectional view taken along line XA-XA of FIG. 9.

FIG. 10B is a cross-sectional view taken along line XB-XB of FIG. 9.

FIG. 11A is an enlarged cross-sectional view of the neighborhood of a common channel in an example of related art.

FIG. 11B is an enlarged cross-sectional view of the neighborhood of a common channel in an example of related art.

FIG. 12A is an enlarged cross-sectional view of the neighborhood of a common channel in an example of related art.

FIG. 12B is an enlarged cross-sectional view of the neighborhood of a common channel in an example of related art.

FIG. 13 is a top view of a cover plate.

FIG. 14 is a schematic diagram illustrating circulation of liquid in the neighborhood of an ejection element substrate.

FIG. 15 is a schematic diagram illustrating circulation of liquid in the neighborhood of an ejection element substrate.

FIG. 16A is a top view and a cross-sectional view of a bypass opening.

FIG. 16B is a top view and a cross-sectional view of a bypass opening.

FIG. 16C is a top view and a cross-sectional view of a bypass opening.

FIG. 17 is a top view of a cover plate in a second embodiment.

FIG. 18A is an enlarged cross-sectional view of the neighborhood of a common channel in the second embodiment.

FIG. 18B is an enlarged cross-sectional view of the neighborhood of a common channel in the second embodiment.

### DESCRIPTION OF THE EMBODIMENTS

Various exemplary embodiments, features, and aspects of the present disclosure will now be described while referring to the drawings. Note that the embodiments described below are not intended to limit the matters disclosed herein, and not all combinations of the features described in the embodiments are necessarily essential to solutions proposed in the present disclosure. The same reference numerals are assigned to the same components.

A liquid ejecting head and a liquid ejecting apparatus according to the present disclosure can be applied to various kinds of devices such as a printer, a copier, a facsimile equipped with a communication system, and a word processor equipped with a printing unit, and further to various kinds of industrial recording apparatuses combined in a complex manner with various kinds of processors. Furthermore, a liquid ejecting head and a liquid ejecting apparatus according to the present disclosure can be used also for, for example, biochip fabrication, electronic circuit printing, printing on a non-absorbent medium, and the like.

### First Embodiment

A liquid ejecting head according to the present embodiment is an inkjet head configured to eject ink. A liquid ejecting apparatus according to the present embodiment is an inkjet recording apparatus. However, these examples do not imply any limitation. The present disclosure may be applied to any head or apparatus, etc. as long as it is configured to eject liquid.

### Liquid Ejecting Apparatus

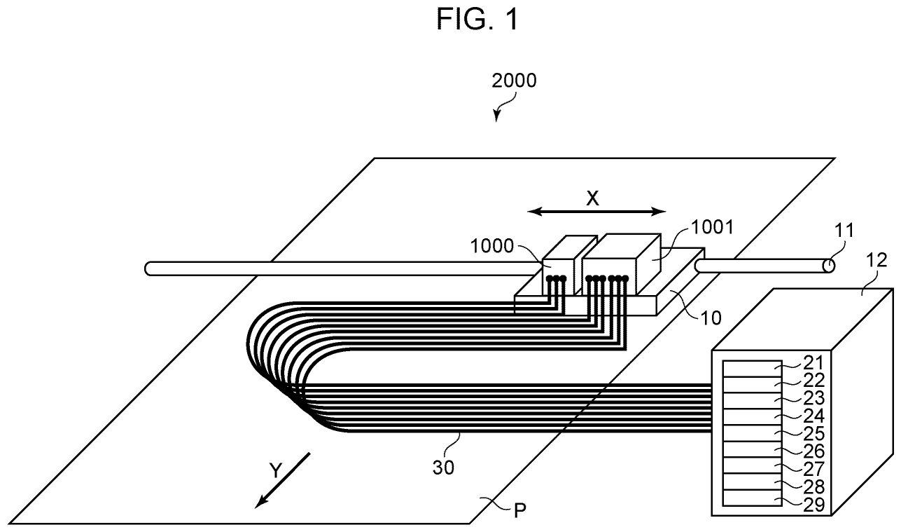

FIG. 1 is a schematic perspective view of a liquid ejecting apparatus 2000 to which a liquid ejecting head 1000 and a liquid ejecting head 1001 according to the present embodiment can be applied. The liquid ejecting apparatus 2000 according to the present embodiment is a serial-scan-type recording apparatus configured to eject liquid (hereinafter referred to as “ink”) from the liquid ejecting head 1000 and the liquid ejecting head 1001 that move in the X direction, thereby recording an image on a recording medium P that moves in the Y direction. The liquid ejecting head 1000 and the liquid ejecting head 1001 can be mounted on a carriage 10. The carriage 10 moves in the X direction (referred to also as “main-scanning direction”) along a guide shaft 11. The recording medium P is conveyed in a sub-scanning direction, which intersects with (in the present embodiment, is orthogonal to) the main-scanning direction by a conveying roller that is not illustrated. The sub-scanning direction is the Y direction. That is, the carriage 10 moves relatively in relation to the recording medium P onto which the liquid is ejected from the liquid ejecting head.

In the present embodiment, a so-called serial-type liquid ejecting head configured to eject ink while moving in the main-scanning direction is taken as an example; however, this does not imply any limitation. That is, the liquid ejecting head may be a so-called full-line-type head that has ejection orifices formed in the width direction of the recording medium P and is capable of performing ejection throughout the entire width-directional area of the recording medium P without involving any movement in the main-scanning direction. The liquid ejecting head 1000 and the liquid ejecting head 1001 are mounted on the carriage 10. The liquid ejecting head 1000 is capable of ejecting three types of ink. The liquid ejecting head 1001 is capable of ejecting six types of ink. Ink is supplied in a pressurized manner to the former and latter liquid ejecting heads from nine types of ink tanks (21, 22, 23, 24, 25, 26, 27, 28, and 29) through respective ink supply tubes 30. A supply pump for pressurized supply, which will be described later, is mounted in an ink supply unit 12.

As a variation example, the three types of ink of the liquid ejecting head 1000 may be modified into the same type of ink to reduce the number of ink tank types to seven. As another variation example, an additional liquid ejecting head may be mounted to configure a liquid ejecting apparatus capable of ejecting twelve or more types of ink. That is, the types of liquid ejected from the liquid ejecting head 1000 are not limited, nor are the types of liquid ejected from the liquid ejecting head 1001.

The liquid ejecting head 1000 is fixed to, and is supported by, the carriage 10 by a positioner and an electric contact of the carriage 10, and performs recording by ejecting ink while being moved in its scanning direction, namely, the X direction.

### Liquid Ejecting Head

Next, a liquid ejecting head will now be described. In the present embodiment, the sole difference between the liquid ejecting head 1000 and the liquid ejecting head 1001 lies in the types of liquid that they eject; therefore, in the description below, the liquid ejecting head 1000 is taken as an example.

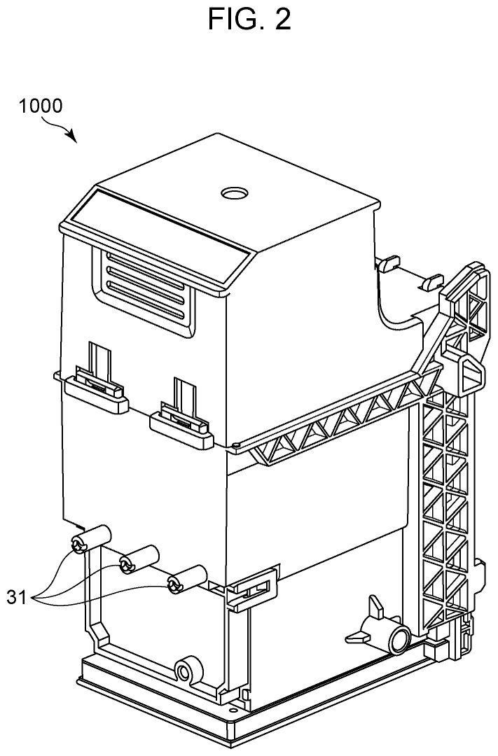

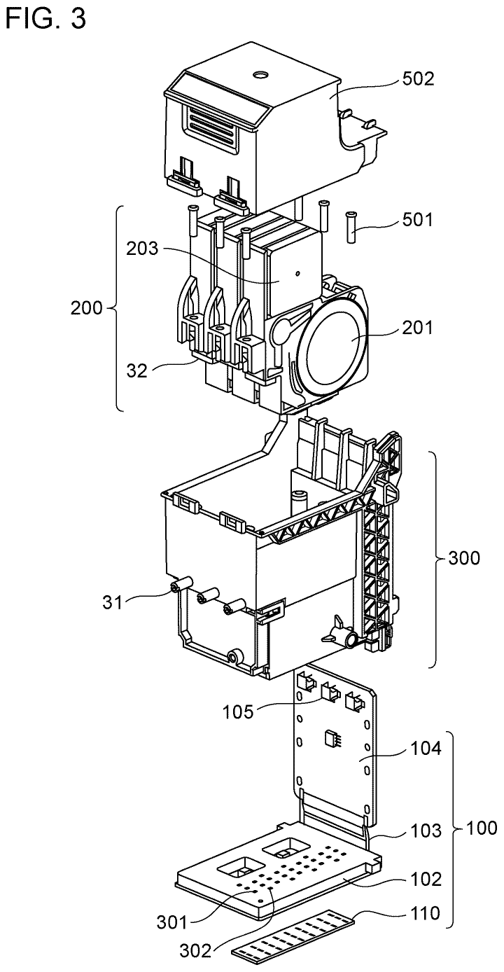

FIG. 2 is a perspective view of the liquid ejecting head 1000 according to the present embodiment. FIG. 3 is an exploded perspective view of the liquid ejecting head 1000. The liquid ejecting head 1000 includes an ejection element unit 100, a circulation unit 200, a head casing unit 300, and a cover 502.

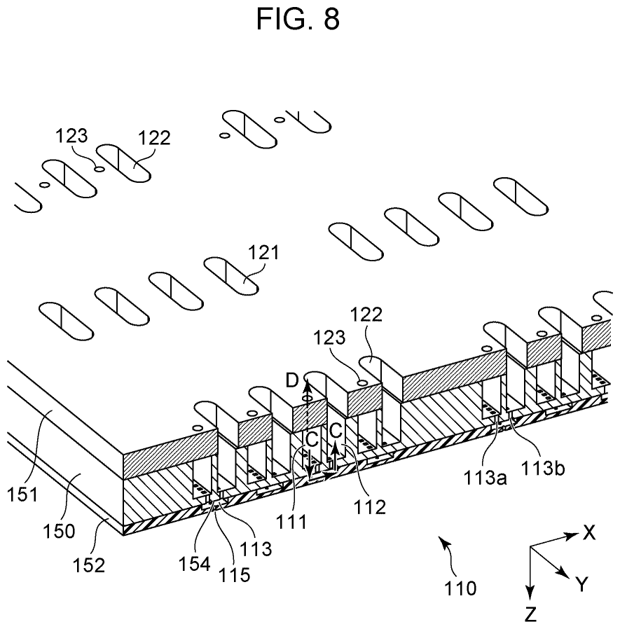

The ejection element unit 100 includes an ejection element substrate 110 (referred to also as “ejection substrate”) for ejecting liquid, a supporting member 102 (referred to also as “supporting substrate”) that supports the ejection element substrate 110, an electric wiring tape 103, and an electric contact substrate 104. A plurality of ejection orifice rows each configured as an array comprised of a plurality of ejection orifices 115 (see FIG. 8) arranged in the Y direction for ejecting the liquid is formed in the ejection element substrate 110. The ejection orifice rows are provided as plural rows in the X direction.

The electric contact substrate 104 includes an electric contact with the carriage 10, and supplies a driving signal and energy to a circulation pump 203 mounted in the circulation unit 200 via a circulation unit connector 106 and non-illustrated pump wiring. The electric contact substrate 104 supplies a driving signal and energy for ejecting ink to the ejection element substrate 110 via the electric wiring tape 103. An anisotropic conductive film (not illustrated), wire bonding, soldering, or the like may be used for the electric connection; however, the method for the connection is not limited to these examples. In the present embodiment, wire bonding is used for the connection between the ejection element substrate 110 and the electric wiring tape 103, and the electrically connected portion is sealed by a sealant (not illustrated) for protection against corrosion by ink and external shock.

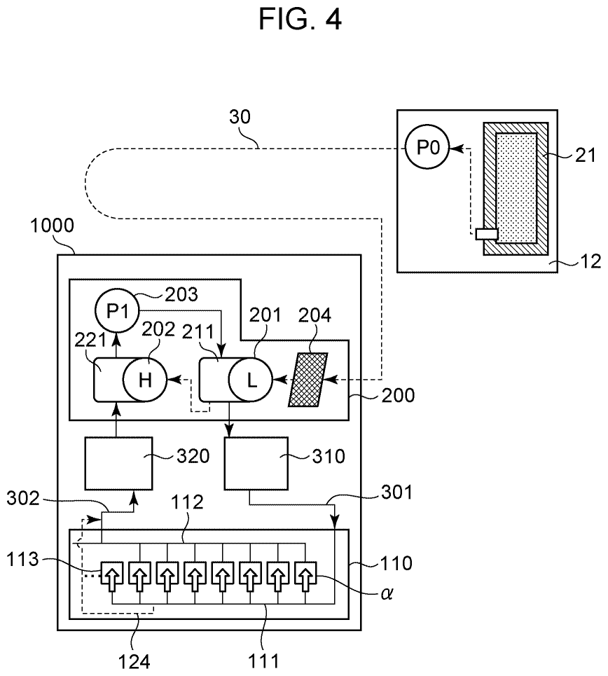

The circulation unit 200 includes a first pressure regulation mechanism 201, a second pressure regulation mechanism 202 (see FIG. 4), and the circulation pump 203. Ink is supplied from the ink tanks to ink supply ports 32 through the ink supply tubes 30, and via the head casing unit 300 having tube connectors 31. In the present embodiment, the circulation unit 200 is fastened to the head casing unit 300 with screws 501 to constitute ink supply channels. An elastic member such as a rubber, an elastomer, or the like is used as a sealing member used at a joint portion in the ink supply channel. The ejection element unit 100 is fixed by bonding to the head casing unit 300 to constitute the ink supply channels. For the purpose of positioning with respect to the carriage 10 and for the purpose of forming an ink channel shape, the head casing unit 300 is configured by combining resin that contains a filler with injection-molded parts.

FIG. 4 is a schematic view of a circulation route of ink corresponding to one color in a steady state applied to the liquid ejecting apparatus 2000 according to the present embodiment. Ink is supplied in a pressurized manner from the ink tank 21 to the liquid ejecting head 1000 by being driven by a supply pump P0. The ink supplied from the ink tank 21 passes through a filter 204 provided inside the liquid ejecting head 1000. In this process, the filter 204 traps a foreign object that is present in the ink and thus reduces the risk of poor ejection that might be caused otherwise by the arrival of the foreign object at the neighborhood of the ejection orifice.

The ink having passed through the filter 204 is supplied to the first pressure regulation mechanism 201. In FIG. 4, the first pressure regulation mechanism 201 is labeled as “L”, and the second pressure regulation mechanism 202 is labeled as “H”. The label “H” means that negative pressure is high. The label “L” means that negative pressure is low. This is the opposite of a high/low relationship that is based on positive pressure. The first pressure regulation mechanism 201 regulates the pressure of a first pressure control chamber 211 to a predetermined pressure (negative pressure).

The circulation pump 203 is a diaphragm pump that sends liquid by alternate movement of two non-return valves due to pressure variations caused by changing the internal capacity of a pump chamber by inputting a driving voltage to a piezoelectric element bonded to a diaphragm. The pressure of a second pressure control chamber 221 is regulated to be lower than that of the first pressure control chamber 211 by the second pressure regulation mechanism 202. The circulation pump 203 sends the liquid from the second pressure control chamber 221 on the lower pressure side (higher in negative pressure) toward the first pressure control chamber 211 on the higher pressure side (lower in negative pressure). In the present embodiment, a piezoelectric-drive-type diaphragm pump is employed, taking into consideration the size and weight of the liquid ejecting head, as well as the ease of transmitting drive energy. A motor, an air-operated valve (air supply and electromagnetic valve control), and the like can also be employed as other kinds of drive source. The liquid-sending capability of the circulation pump 203 will be described later.

The circulation pump 203 is not limited to a diaphragm pump. However, a preferred example is a diaphragm pump because the circulation pump 203 may preferably be compact enough so that it can be mounted in the liquid ejecting head 1000.

The ejection element substrate 110 includes a plurality of pressure compartments 113 where pressure generated by the driving of ejection elements acts on the liquid that is to be ejected from a plurality of ejection orifices. A plurality of common supply channels 111 extending in the direction along the ejection orifice array and configured to supply the liquid to the plurality of pressure compartments 113 is connected to each of the pressure compartments 113. A plurality of common collection channels 112 extending in the direction along the ejection orifice array and configured to collect the liquid from the plurality of pressure compartments 113 is connected to each of the pressure compartments 113.

The common supply channel 111 is connected to a distributing channel 301 for distributing the liquid to the plurality of common supply channels 111. The plurality of distributing channels 301 is connected to the first pressure control chamber 211 via a first air bubble reservoir channel 310 for retaining air bubbles. That is, the pressure of the first air bubble reservoir channel 310, the distributing channel 301, and the common supply channel 111 is regulated to be on the higher pressure side (the upstream side).

The common collection channel 112 is connected to a merging channel 302 for merging the liquid from the plurality of common collection channels 112. The plurality of merging channels 302 is connected to the second pressure control chamber 221 via a second air bubble reservoir channel 320 for retaining air bubbles. That is, the pressure of the second air bubble reservoir channel 320, the merging channel 302, and the common collection channel 112 is regulated to be on the lower pressure side (the downstream side).

Since the pressure is regulated to the upstream side (the higher pressure side) and the downstream side (the lower pressure side) as described above, a pressure difference arises between the common supply channel 111 and the common collection channel 112 to generate the flow of ink in the direction indicated by the arrow α in FIG. 4 in each of the pressure compartments 113. Because of the flow of ink caused by such a pressure difference, ink whose viscosity has increased locally during waiting or during printing at the ejection orifice where no ejection is performed and in the neighborhood of the pressure compartment is collected from the pressure compartment 113; therefore, it is possible to suppress poor ejection. In other words, circulating the liquid in the order of the distributing channel, the common supply channel, the pressure compartment, the common collection channel, and the merging channel by the circulation pump 203 suppresses poor ejection.

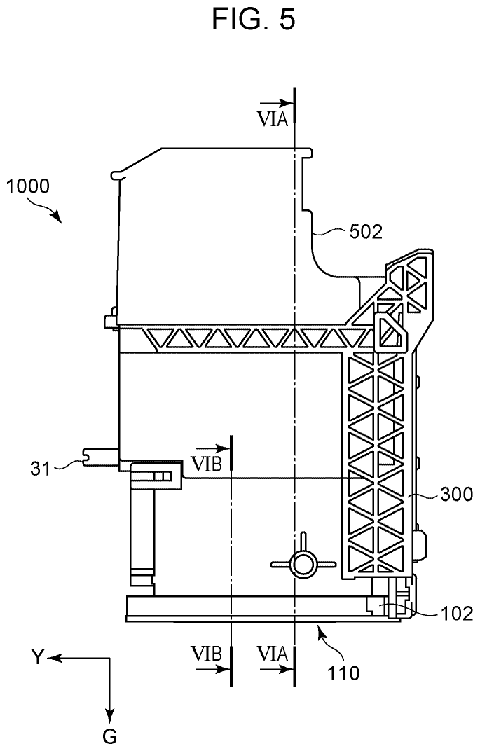

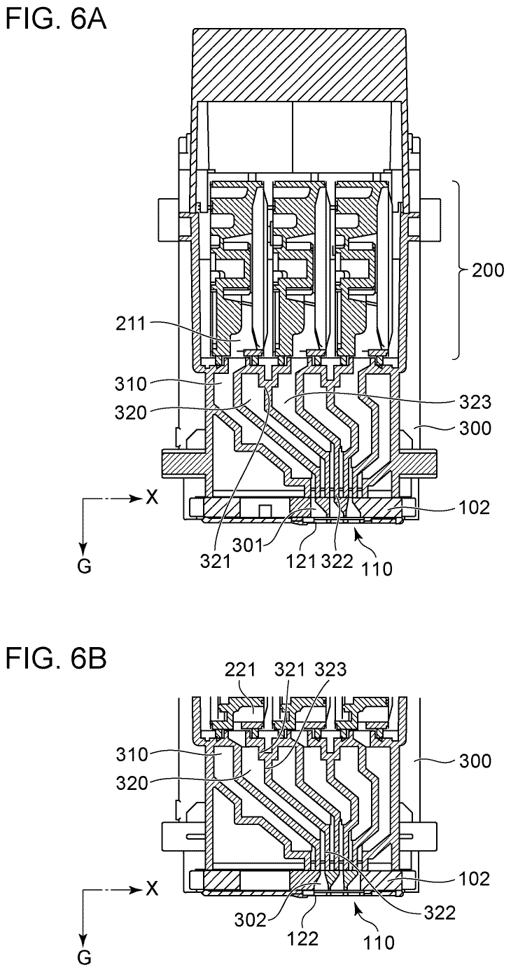

FIG. 5 is a side view of the liquid ejecting head 1000. FIG. 6A is a cross-sectional view taken along the line VIA-VIA of FIG. 5. FIG. 6B is a cross-sectional view taken along the line VIB-VIB of FIG. 5. There are ejection orifice arrays in the Y direction, in which the recording medium P moves, in the ejection element substrate 110, and ink is ejected from the ejection orifices in the direction of gravitational force G.

As illustrated in FIGS. 6A and 6B, the distributing channel 301 and the merging channel 302 are formed in the supporting member 102, which supports the ejection element substrate 110. As illustrated in FIGS. 6A and 6B, the first air bubble reservoir channel 310 and the second air bubble reservoir channel 320 are formed in the head casing unit 300.

The supporting member 102 and the ejection element substrate 110 are connected to each other, with a cover plate 151 (referred to also as “plate-shaped member”) interposed therebetween (see FIG. 8). A supply opening 121 and a collection opening 122 are formed in the cover plate 151. The cover plate 151 is interposed between the ejection element substrate 110 and the supporting member 102, and forms a part of the wall surfaces of the plurality of common supply channels 111 and the plurality of common collection channels 112. The liquid inside the distributing channel 301 is distributed to the common supply channel 111 via the supply opening 121. The liquid inside the common collection channel 112 is merged to the merging channel 302 via the collection opening 122.

Next, the first pressure regulation mechanism 201 and the second pressure regulation mechanism 202 will now be described in detail.

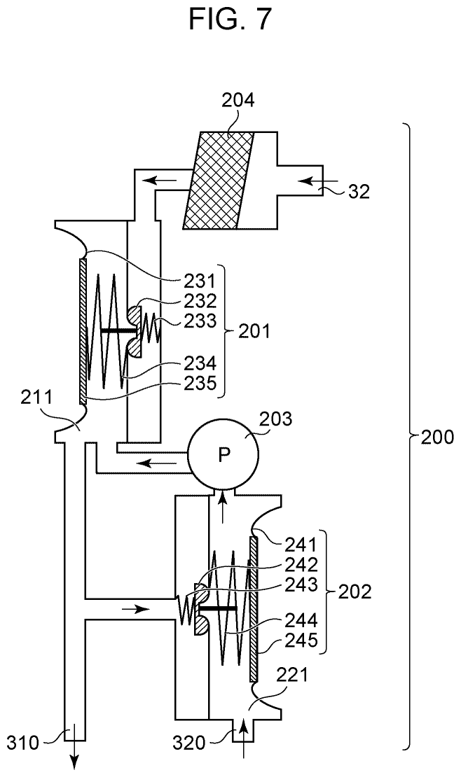

FIG. 7 is an enlarged cross-sectional view of the neighborhood of the first pressure regulation mechanism 201 and the second pressure regulation mechanism 202. As described above, the liquid inside the ink supply unit 12 is supplied to the circulation unit 200 through the ink supply tube 30. Then, the ink is supplied from the ink supply port 32 provided inside the circulation unit 200 to the first pressure regulation mechanism 201 via the filter 204.

The first pressure regulation mechanism 201 includes a valve 232, a valve spring 233, a flexible member 231, a pressure plate 235, and a pressure regulation spring 234. When the volume of the first pressure control chamber 211 decreases as a result of the discharging of ink, etc., the pressure plate 235 causes the flexible member 231 and the pressure regulation spring to deform, thereby behaving to maintain the pressure constant in the first pressure control chamber 211. Compressive deformation of the pressure regulation spring 234 causes the valve spring 233 to deform in a compressing direction via the valve 232, and, by this means, it is possible to supply ink to the first pressure control chamber 211. This behavior makes it possible to keep the supply of the ink and the pressure thereof constant. The negative pressure of the first pressure control chamber 211 is set by the contact position of the pressure plate 235 of the valve 232 and the pressure regulation spring 234.

The second pressure regulation mechanism 202 has the same structure as that of the first pressure regulation mechanism 201, and includes a valve 242, a valve spring 243, a flexible member 241, a pressure plate 245, and a pressure regulation spring 244. The principle of pressure regulation by the second pressure regulation mechanism 202 is the same as that of the first pressure regulation mechanism 201 except that its ink supply source is changed to the first pressure control chamber 211.

The circulation pump 203 is connected in such a way as to send the ink of the second pressure control chamber 221 to the first pressure control chamber 211. The circulation pump 203 according to the present embodiment is a compact diaphragm pump using piezoelectric elements. Since pump drive operation can be performed by applying a voltage pulse to the piezoelectric element, it is possible to perform ON/OFF control of the circulation pump 203 by means of the voltage pulse outputted from the body. As a result of transferring the ink of the second pressure control chamber 221 to the first pressure control chamber 211 by the circulation pump 203, the first pressure control chamber 211 becomes pressurized by an amount corresponding to the liquid sent, and the second pressure control chamber 221 becomes depressurized by an amount corresponding to the liquid sent. The second pressure control chamber 221 takes in ink via the second pressure regulation mechanism 202 due to the depressurization, but the second pressure regulation mechanism 202 takes in ink from the first pressure control chamber 211 and the pressure compartments 113; therefore, a circulatory flow is produced while keeping the pressure constant. The producing of the circulatory flow via the pressure compartments 113 makes it possible to remove ink whose viscosity has increased due to evaporation in the neighborhood of nozzles and thus makes it possible to perform stable ejection.

### Detailed Explanation of Ejection Element Substrate

FIG. 8 is a perspective view of a cross section of the ejection element substrate 110 and the cover plate 151. In FIG. 8, four ejection orifice rows are formed in an ejection orifice forming member 152 of the ejection element substrate 110; however, the number of the ejection orifice rows is not limited to this example.

The ejection element substrate 110 includes the ejection orifice forming member 152 and a substrate 150. The substrate 150 is preferably formed of silicon, though not limited thereto. A warming heater (not illustrated) for making ink ejection from the ejection orifices 115 stable may preferably be provided on the substrate 150. For the purpose of making the temperature of the entire ejection element substrate uniform and for the purpose of making bonding to the substrate 150 stable, alumina, which has approximately the same linear coefficient of expansion as that of silicon and has high thermal conductivity, may preferably be used as the material of the supporting member 102. Alternatively, a thermal insulation member such as resin may be used for forming the supporting member 102 in order to reduce regions where air bubbles could be produced due to a temperature rise. Similarly, the cover plate 151 may be formed of a thermal insulation member such as resin.

The flow of liquid inside the ejection element substrate 110 will now be described. The cover plate 151 has a function of a cover that constitutes a part of the walls of the common supply channel 111 and the common collection channel 112 that are formed in the substrate 150 of the ejection element substrate 110. In the ejection element substrate 110, the substrate 150 and the ejection orifice forming member 152, the latter of which is formed of photosensitive resin, are stacked in layers, and the cover plate 151 is bonded to the back of the substrate 150. Ejection elements 154 are formed in one surface of the substrate 150, and grooves forming the common supply channels 111 and the common collection channels 112 extending along the ejection orifice array are formed in the back thereof.

The ejection element 154 may be a thermoelectric conversion element that generates pressure by converting electric energy given thereto to thermal energy, or may be a piezoelectric element that generates pressure by converting electric energy given thereto to mechanical energy. No limitation is intended here, and any element, etc. may be employed as long as it is capable of generating energy for ejecting liquid.

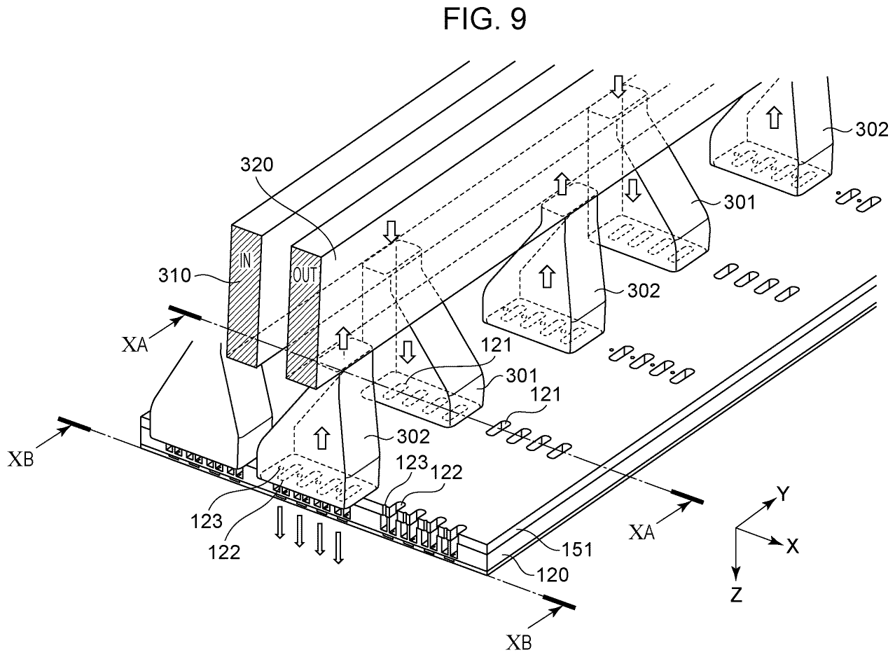

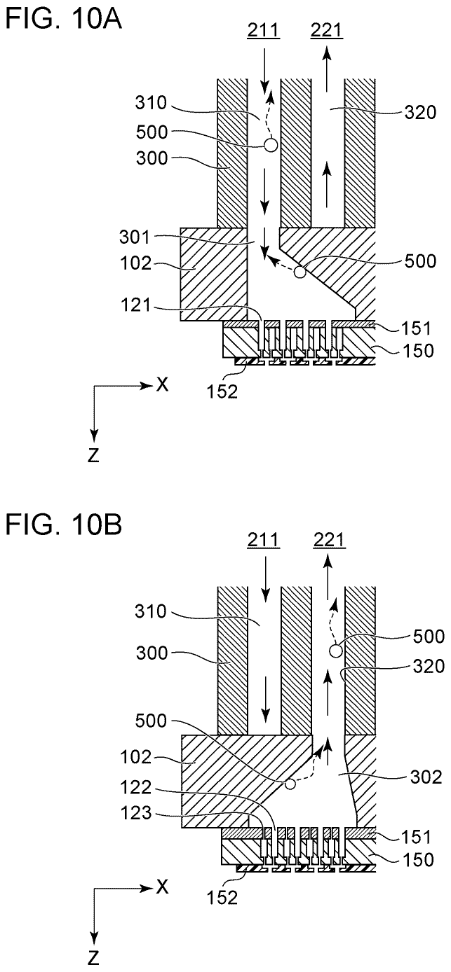

FIG. 9 is a perspective view illustrating, in addition to a structural cross-sectional perspective view of the ejection element substrate 110, channels at a joint portion joined to the head casing unit 300 and to the supporting member 102 such that the reader can understand the flow. FIG. 10A is a structural cross-sectional view taken along the line XA-XA of FIG. 9. FIG. 10B is a structural cross-sectional view taken along the line XB-XB of FIG. 9.

The common supply channel 111 formed by the substrate 150 and the cover plate 151 is connected to the first pressure control chamber 211 via the distributing channel 301 and the first air bubble reservoir channel 310. The common collection channel 112 formed by the substrate 150 and the cover plate 151 is connected to the second pressure control chamber 221 via the merging channel 302 and the second air bubble reservoir channel 320. These connections give rise to a differential pressure between the common supply channel 111 and the common collection channel 112. Due to the differential pressure, the liquid inside the common supply channel 111 provided in the substrate 150 flows to the common collection channel 112 by way of an individual supply channel 116, the pressure compartment 113, and an individual collection channel 117 (see the arrow C in FIG. 8). By means of such ink circulation, it is possible to collect ink whose viscosity has increased due to evaporation from the ejection orifice 115, an air bubble, and the like from the common supply channel 111 to the common collection channel 112 at the ejection orifice 115 where no ejecting operation is performed and in the pressure compartment 113. Furthermore, it is possible to reduce the risk of an increase in the viscosity of ink at the ejection orifice 115 and in the pressure compartment 113, and reduce the risk of an increase in the concentration of a colorant in ink. The liquid having been collected to the common collection channel 112 is further collected to the second air bubble reservoir channel 320 via the collection opening 122 and the merging channel 302.

In a liquid ejecting head according to the present embodiment, a bypass opening(s) 123 for connecting the common supply channel 111 to the merging channel 302 without going through the pressure compartment 113 is formed in the cover plate 151. Therefore, it is possible to collect an air bubble 500 having entered the common supply channel 111 or having been produced therein from the common supply channel 111 to the merging channel 302 by using the differential pressure between the common supply channel 111 and the merging channel 302 (see the arrow D in FIG. 8). The air bubble 500 having been collected to the merging channel 302 flows to the second air bubble reservoir channel 320 and is then temporarily retained thereat.

In FIGS. 10A and 10B, the arrow (solid line) shown in the channel indicates the flow of ink that circulates by being driven by the circulation pump 203 during non-recording (during non-ejection). In FIG. 10A, the ink flows from the first pressure control chamber 211 to the common supply channel 111 via the head casing unit 300 constituting the first air bubble reservoir channel 310, the distributing channel 301, and the supply opening 121. Then, the ink flows from the common supply channel 111 to the common collection channel 112 through the pressure compartment 113 where ink ejection is performed, and is collected to the second air bubble reservoir channel 320 via the collection opening 122 and the merging channel 302. The liquid having flowed into the second air bubble reservoir channel 320 further flows to the second pressure control chamber 221. The circulation pump 203 sends the ink from the second pressure control chamber 221 to the first pressure control chamber 211. In this way, the ink completes one full circulation cycle.

As described above, the ink circulation according to the present embodiment takes place entirely in a self-contained manner within the flow route inside the liquid ejecting head 1000; therefore, no ink collection tube for collecting ink from the liquid ejecting head 1000 to the liquid ejecting apparatus is needed.

It follows that the air bubble 500 having been produced inside the channel in the liquid ejecting head 1000 is present somewhere in the route of circulation. The air bubble 500 is produced, for example, during the filling of ink into the liquid ejecting head, due to foaming caused by the flow of ink, due to oversaturation of dissolved gases in the ink resulting from a temperature rise or a pressure reduction inside the channel, or the like. If the air bubble 500 is sucked into the pressure compartment 113, it might affect the behavior of the ink, resulting in poor ejection. Therefore, it may be desirable to cause the air bubble 500 to be retained at a circulatory channel region distant from the pressure compartment 113 so as to prevent it from flowing into the pressure compartment 113.

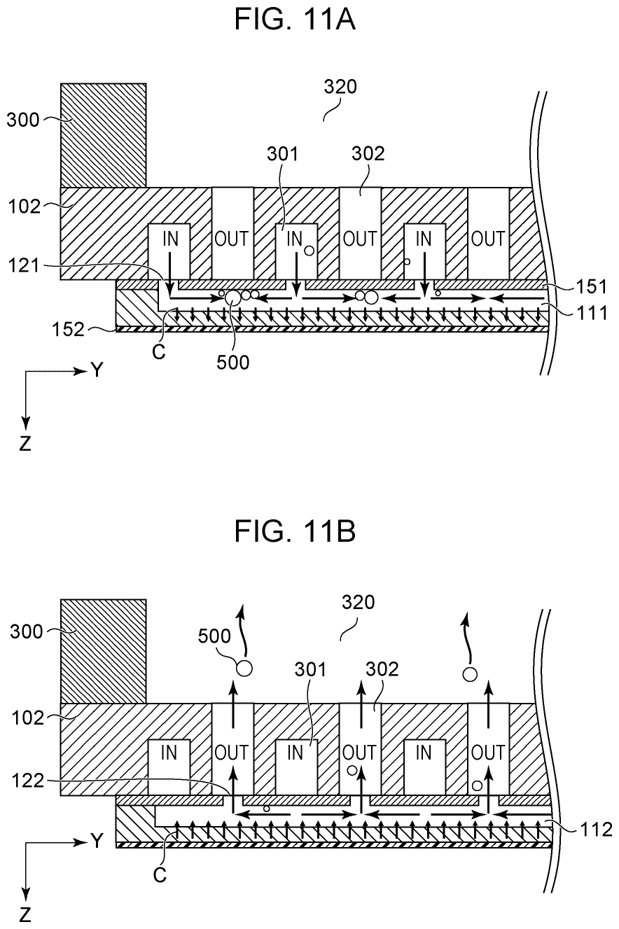

FIGS. 11A and 11B are enlarged cross-sectional views of a common channel of a liquid ejecting head according to related art. FIG. 11A illustrates the neighborhood of the common supply channel 111 in a cross section in an enlarged manner. FIG. 11B illustrates the neighborhood of the common collection channel 112 in a cross section in an enlarged manner. In a liquid ejecting head, control, etc. for making the temperature of the ejection element substrate 110 uniform by using a warming heater is sometimes performed for the purpose of enhancing print quality by making an amount of ink ejection stable. In a case where an ejection scheme using a heat generation element as an ejection element is employed, as in a liquid ejecting head according to the present embodiment, the temperature of the ejection element substrate 110 rises. In such a case, the temperature of ink circulating through the common supply channel 111 also rises due to heat from the warming heater and the heat generation element; therefore, an amount of saturated dissolved gas decreases locally, causing the dissolved gas to form bubbles. The air bubbles 500 produced by the temperature rise gather near a confluence portion where the liquid flowing into the common supply channel 111 through the plurality of supply openings 121 merges therewith, and a force of buoyancy (in the-Z direction in FIG. 11A) and a force of circulatory flow (in the Z direction in FIG. 11A) act on the air bubble 500. At this time, if the force of buoyancy is greater in magnitude than the force of circulatory flow, the air bubble 500 is not entrained into the pressure compartment 113 and stagnates in the neighborhood of the ceiling of the confluence portion. Since no opening for allowing the air bubble 500 to escape is formed in this portion, there is a possibility that the air bubble 500 might stay without being let out. Then, when the force of the circulatory flow becomes greater in magnitude than the force of the buoyancy, there is a risk of the entry of the air bubble having stayed in the neighborhood of the ceiling into the pressure compartment or the clogging of the channel by the air bubble, resulting in poor ejection.

On the other hand, as illustrated in FIG. 11B, since the direction in which a force of buoyancy acts on the air bubble 500 produced in the common collection channel 112 (the −Z direction) is the same as the direction in which a force of circulatory flow acts thereon (the −Z direction), the air bubble inside the common collection channel 112 flows through the collection opening 122 into the merging channel 302.

As explained above, in a liquid ejecting head according to related art, the air bubble 500 is prone to stagnate in the common supply channel 111 that is near the pressure compartment 113, and there is a risk of causing poor ejection due to entrainment of the air bubble into the pressure compartment 113.

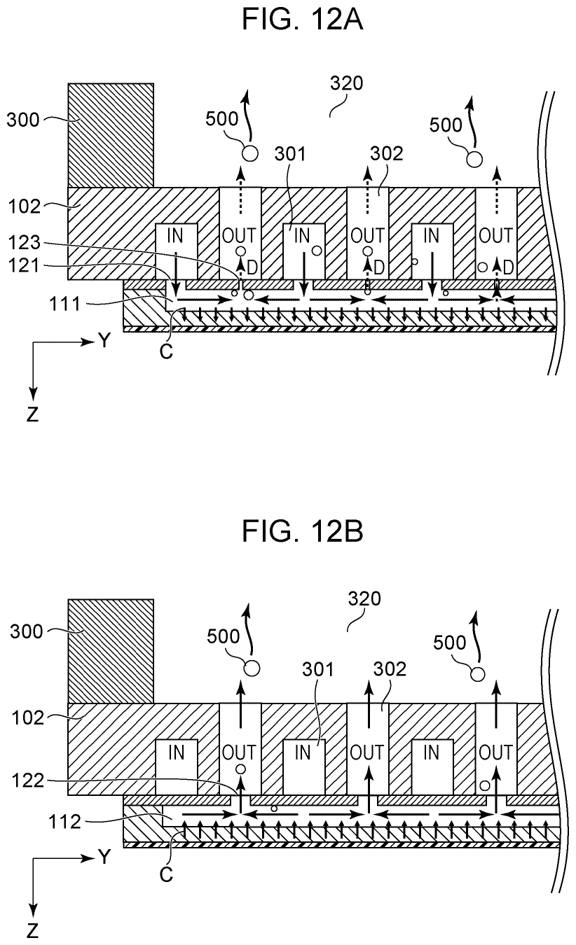

Next, FIGS. 12A and 12B, which are enlarged cross-sectional views of the common channel of the liquid ejecting head according to the present embodiment, will now be described. FIG. 12A illustrates the neighborhood of the common supply channel 111 in a cross section in an enlarged manner. FIG. 12B illustrates the neighborhood of the common collection channel 112 in a cross section in an enlarged manner. In the liquid ejecting head according to the present embodiment, the bypass opening(s) 123 for connecting the common supply channel 111 to the merging channel 302 without going through the pressure compartment 113 is formed. The location where the bypass openings 123 are formed is near the confluence portion of the liquid having flowed from the plurality of supply openings 121 and at the ceiling portion of the common supply channel 111 where air bubbles are likely to accumulate. In other words, the bypass openings 123 are formed in a plate-shaped member (the cover plate 151). Since the bypass openings 123 are formed at a position where air bubbles tend to stagnate in the common supply channel 111, the air bubbles inside the common supply channel 111 are collected to the merging channel 302 via the bypass openings 123 (see the arrow D in FIG. 12A).

The air bubbles 500 collected to the merging channel 302 flow into the second air bubble reservoir channel 320 due to buoyancy and the circulatory flow. As illustrated in FIGS. 6A and 6B, the second air bubble reservoir channel 320 has a narrower channel width on the side connected to the merging channel 302 for collecting liquid from the merging channel 302, and has a wider channel width on the side connected to the second pressure control chamber 221. In other words, the second air bubble reservoir channel 320 includes a first portion 322 and a second portion 323 inside, the latter of which is positioned above the former in the vertical direction when the liquid ejecting head is in use. The channel width of the second portion 323 is greater than that of the first portion 322. Accordingly, after collecting liquid from the merging channel 302, which is located in a densely packed channel region, many air bubbles can be retained in the second portion 323. Here, the term “channel width” refers to a channel width in a predetermined direction (the Y direction). The “use state of the liquid ejecting head” refers to the posture in which the liquid ejecting head ejects ink to record an image, characters, or the like on a recording medium.

If air bubbles intrude from the second air bubble reservoir channel 320 into the second pressure control chamber 221, the second pressure regulation mechanism might fail to function properly because the second pressure control chamber 221 opens and closes its valve according to internal pressure. Accordingly, as illustrated in FIGS. 6A and 6B, the second air bubble reservoir channel 320 has a plurality of bent portions 321. Providing the bent portions 321 makes it easier to retain air bubbles near the bent portions 321, and to suppress the intrusion of air bubbles into the second pressure control chamber 221.

On the other hand, as illustrated in FIG. 12B, the air bubbles 500 produced in the common collection channel 112 are, as in the related art, collected to the merging channel 302 via the collection openings 122. Since a circulatory flow is generated by the circulation pump 203 inside the liquid ejecting head, even though the bypass openings 123 are formed, the liquid rarely flows from the merging channel 302 to the bypass openings 123.

As described above, in the liquid ejecting head according to the present embodiment, because the bypass openings 123 are provided, the risk of air bubbles stagnating in the common supply channel 111, which is in the neighborhood of the pressure compartments 113, is reduced. That is, it is possible to reduce the risk of air bubbles stagnating in the channel near the pressure compartment 113 without increasing the size of the liquid ejecting head and the liquid ejecting apparatus; therefore, it is possible to suppress poor ejection. Furthermore, since air bubbles, which are prone to stagnate in the common supply channel 111 near the pressure compartment 113, can be kept away from the ejection element substrate 110, continuous printing for a long time is possible. Therefore, the liquid ejecting head according to the present embodiment is suitable for large-format printing such as large-sized posters.

A mechanism for discharging air bubbles retained in the second air bubble reservoir channel 320 to the outside of the liquid ejecting head may be provided. For example, a mechanism in which a part of wall surfaces of a circulatory channel is formed of a film that blocks liquid but allows gas to pass, and the end of the film is depressurized to discharge air bubbles, may be provided.

As another location for providing a similar bypass opening, it is conceivable to form an opening at a position inside the ejection element substrate 110 that is not through the pressure compartment, to provide a bypass. Such a bypass, if provided, will make it possible to circulate a larger amount of ink inside the ejection element substrate without increasing the differential pressure between the upstream-side channel and the downstream-side channel with respect to the pressure compartment. However, if such a bypass opening is provided, an increase in the amount of a circulating flow causes pressure loss, and a variation in pressure between different pressure compartments may occur, possibly leading to poor ejection. Particularly, when a bypass opening and a bypass passage are provided at an end of a relatively fine channel, an increase in flow rate through the channel causes an increase in flow resistance, making it more likely for pressure variation and poor ejection to occur.

By contrast, when the common supply channel 111 and the merging channel 302 are connected by the bypass opening 123 without going through the pressure compartment 113, as in the liquid ejecting head according to the present embodiment, it is possible to make the length of the bypass passage shorter. Therefore, it is possible to suppress pressure variation while reducing the size of the ejection element substrate 110.

Widening the channel widths of the common supply channel 111 and the common collection channel 112 makes it possible to reduce the channel resistance; therefore, this is advantageous in terms of suppressing pressure variation. However, if the channel widths of the common supply channel 111 and the common collection channel 112 are widened, the ejection element substrate 110 becomes larger, which is disadvantageous in terms of cost. In the liquid ejecting head according to the present embodiment, even though the bypass opening 123 is provided, it is possible to make the channel width of the common supply channel 111 and the common collection channel 112 narrow, specifically, a narrow width of 250 μm or less. Here, the “channel width of the common supply channel 111” refers to the length of the common supply channel in the array direction of the common supply channel array comprised of a plurality of common supply channels. Similarly, the “channel width of the common collection channel 112” refers to the length of the common collection channel in the array direction of the common collection channel array comprised of a plurality of common collection channels.

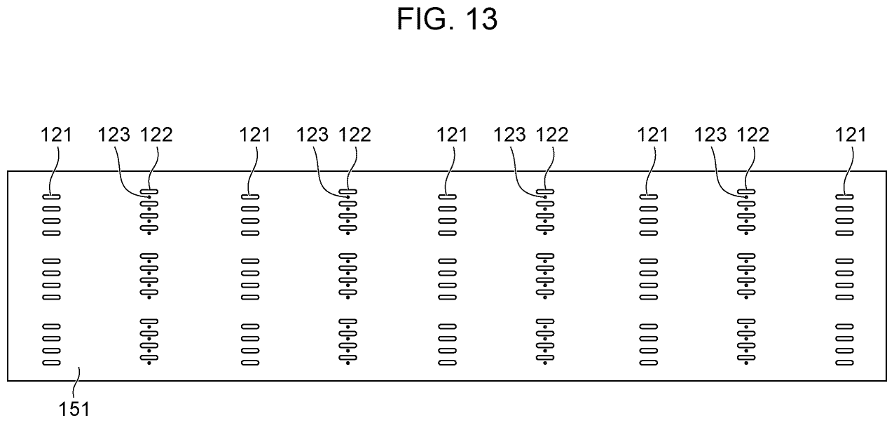

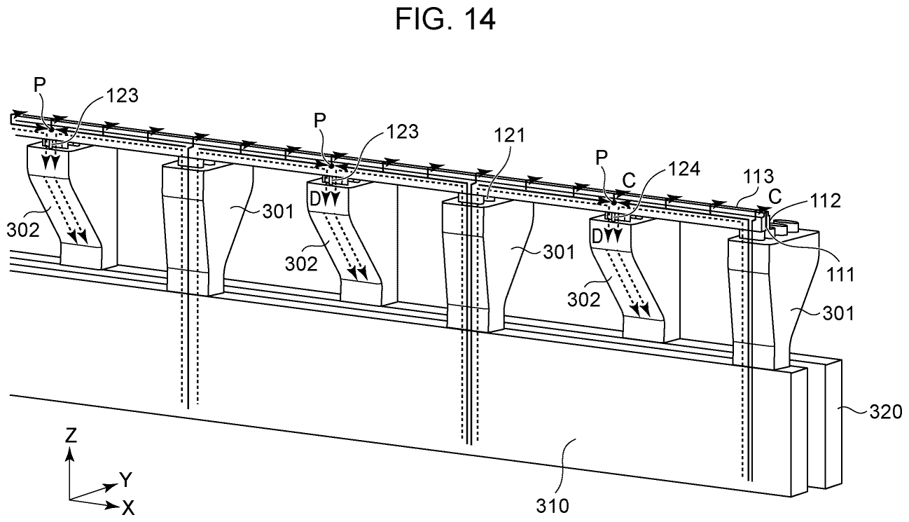

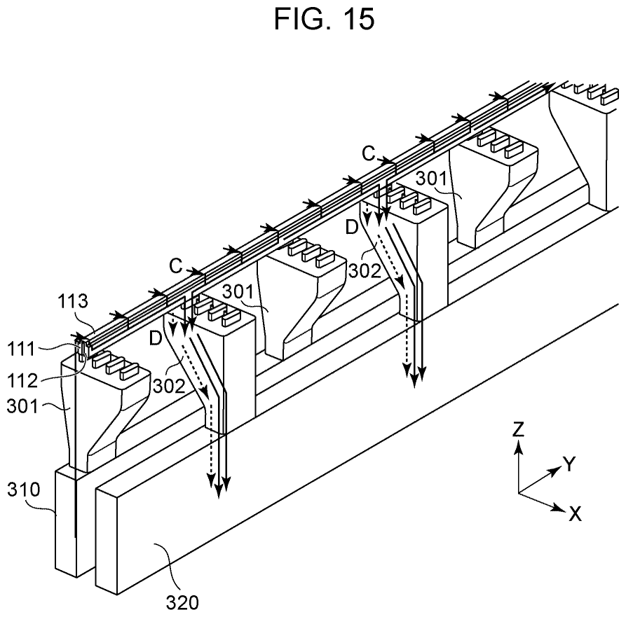

Next, the position where the bypass opening(s) 123 is formed will now be described in detail. FIG. 13 is a top view of the cover plate 151. FIG. 13 illustrates the cover plate 151 corresponding to the ejection element substrate 110 that has four ejection orifice rows and is capable of ejecting three types of ink. FIGS. 14 and 15 are schematic views illustrating the flow of ink in the neighborhood of the bypass openings 123. Note that FIGS. 14 and 15 each schematically illustrate one of the ejection orifice rows and a channel portion connected thereto (portion where ink is present). In FIGS. 14 and 15, the arrows indicate the flow of ink.

As illustrated in FIG. 13, the supply openings 121 corresponding to one ejection orifice row are provided at five places, and they are formed at positions including both end portions of the common supply channel 111 to which they are connected. The collection openings 122 corresponding to one ejection orifice row are provided at four places. The collection openings 122 are not formed at both end portions of the common collection channel 112.

Since the common supply channel 111 and the common collection channel 112 have narrow widths of 250 μm or less, the shorter the distance by which the ink flows inside the ejection element substrate in the ink flow (arrow C) from the common supply channel to the pressure compartment 113 illustrated in FIG. 14, the greater the suppression of pressure variation due to pressure loss. Therefore, it is preferable to arrange the supply openings 121 and the collection openings 122 at approximately equal intervals as illustrated in FIG. 13.

FIG. 15 illustrates the flow (arrow C) of ink that is collected from the pressure compartment 113 to the common collection channel 112. The ink collected to the common collection channel 112 flows toward the collection opening 122 (solid arrow in FIG. 15), and is then collected to the merging channel 302 through the collection opening 122.

The flow of ink from the common supply channel 111 via the pressure compartment 113 (arrow C and solid arrow) takes the direction that makes the total flow-passage length including the common collection channel 112 the shortest. Therefore, the confluence point P of the ink flow inside the common supply channel 111 is located near the collection opening 122. The flow of ink (dotted arrow D) that goes from the supply opening 121 illustrated in FIG. 14 through the inside of the common supply channel 111 and is collected to the merging channel 302 via the bypass opening 123 discharges an air bubble inside the common supply channel 111 without going through the pressure compartment 113. As described above, from the standpoint of efficiently discharging an air bubble inside the common supply channel 111 to the merging channel 302, it is preferable to provide the bypass opening 123 in the vicinity of the confluence point P of the ink flow inside the common supply channel 111. Since an air bubble needs to be discharged to the merging channel 302 before it is entrained into the pressure compartment 113, it is preferable to provide the bypass opening 123 at a position that is opposite to the direction of the flow toward the pressure compartment 113 (arrow C) and that enables the air bubble to be efficiently discharged by buoyancy. In other words, it is preferable to locate the bypass opening 123 in the cover plate 151.

In the array direction of a collection opening row configured as an array comprised of a plurality of collection openings 122, the bypass opening 123 is formed between the plurality of collection openings 122. With this layout, in a common channel array configured by alternately arranging the common supply channels 111 and the common collection channels 112, the bypass openings 123 can be provided at a position corresponding to the common supply channel 111.

Moreover, in the array direction of a supply opening row configured as an array comprised of a plurality of supply openings 121, the bypass opening 123 is formed between the plurality of supply openings 121. With this layout, the bypass opening 123 can be provided at a location where liquid having flowed into the common supply channel 111 from the plurality of supply openings 121 merges, making it easier to collect the air bubbles 500 to the merging channel 302.

As illustrated in FIGS. 14 and 15, it is preferable that, in the array direction of the ejection orifice row, the distributing channels 301 and the merging channels 302 be arranged alternately. It is also preferable to alternate the directions of the protruding shapes between the distributing channels 301 and the merging channels 302. This makes it possible to provide many distributing channels 301 and merging channels 302 in a narrow region of the supporting member 102.

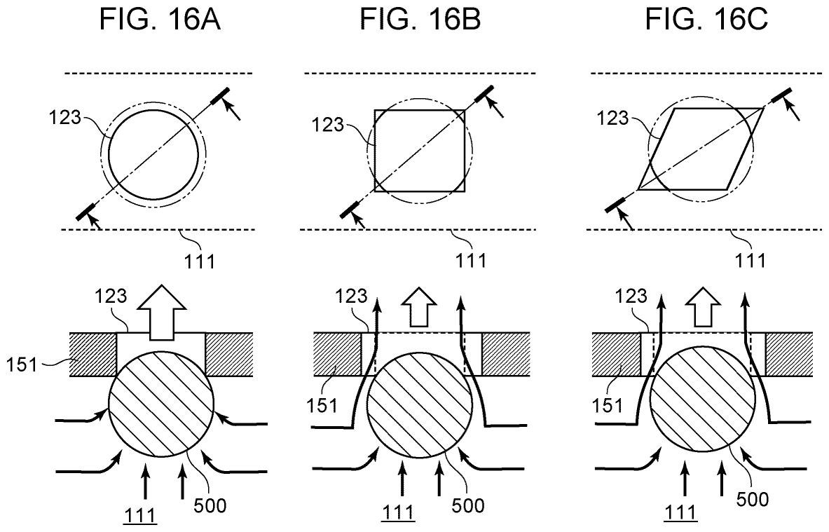

Next, the shape of the bypass opening 123 will now be described. FIGS. 16A, 16B, and 16C illustrate the bypass opening viewed from above, and show cross-sectional views obtained by cutting the bypass opening obliquely. The bypass opening 123 according to the present embodiment has a circular opening shape with an opening diameter of about 0.1 mm as illustrated in FIG. 16A. The thickness of the bypass opening 123 is equal to the thickness of the cover plate 151 and is approximately 0.3 mm.

As the opening diameter of the bypass opening 123 increases, the amount of flow inside the common supply channel 111 increases, which increases pressure variation among the respective pressure compartments 113. Furthermore, if the opening diameter of the bypass opening 123 is large, the liquid-sending capacity that the circulation pump 203 may have increases in order to maintain the differential pressure between the upstream-side channel and the downstream-side channel of the pressure compartment 113. For these reasons, it is preferable that the bypass opening 123 be made narrow among diameters that allow air bubbles to pass.

As illustrated in FIG. 16A, the opening shape of the bypass opening 123 according to the present embodiment is circular. When the opening shape of the bypass opening 123 is circular (at least elliptical), an air bubble 500 is trapped in such a way as to close the bypass opening 123, whereby the circulatory flow acts on the entirety of the air bubble 500, and the air bubble 500 can pass through the bypass opening 123 while deforming itself. The bypass opening 123 having such an opening shape can be formed by applying dry etching to a silicon substrate.

FIGS. 16B and 16C illustrate variation examples of the bypass opening. The opening shape of the bypass opening illustrated in FIG. 16B is rectangular, and the opening shape of the bypass opening illustrated in FIG. 16C is a parallelogram. When the opening diameter of the bypass opening 123 is small, for an air bubble that is larger than the opening diameter, a reaction force is generated that resists the dynamic pressure of the flow of ink and the buoyancy of the air bubble due to the surface tension of the air bubble. When the opening shape of the bypass opening is rectangular or parallelogram, the air bubble is trapped without closing the bypass opening, and thus the air bubble can pass through the bypass opening while deforming itself due to the dynamic pressure of the ink flow caused by the circulatory differential pressure and due to the buoyancy. Bypass openings having these shapes can be formed by performing photolithography on a member such as silicon or photosensitive resin.

If the opening diameter of the bypass opening 123 is larger than that of the collection opening 122, the amount of liquid flowing from the common supply channel 111 to the merging channel 302 via the bypass opening 123 is larger than the amount of liquid flowing from the common supply channel 111 to the merging channel 302 via the pressure compartment 113. Therefore, it is preferable that the opening diameter of the bypass opening 123 be smaller than that of the collection opening 122.

If the opening diameter of the bypass opening 123 is larger than that of the supply opening 121, the amount of liquid collected from the common supply channel 111 to the merging channel 302 via the bypass opening 123 is larger than the amount of liquid supplied from the distributing channel 301 to the common supply channel 111. Therefore, it is preferable that the opening diameter of the bypass opening 123 be smaller than that of the supply opening 121.

### Liquid-Sending Capability of Circulation Pump in Consideration of Bypass Opening

As illustrated in FIG. 8, the circulatory flow going through the pressure compartment 113 makes it possible to remove ink whose viscosity has increased due to evaporation in the neighborhood of the ejection orifice. At this time, the circulation ink flow rate C may be determined by the viscosity of the ink, the shapes of the pressure compartment 113 and the ejection orifice 115, and the like. The control factor that determines this flow rate C is the pressure difference between the individual supply channel 116 and the individual collection channel 117, and the first pressure regulation mechanism 201 and the second pressure regulation mechanism 202 may keep this pressure difference constant. This differential pressure generates a flow (arrow D in FIG. 8) through the bypass opening 123, too, and the flow rate D is determined. For the first pressure regulation mechanism 201 and the second pressure regulation mechanism 202 to function properly, supply by the circulation pump 203 at a flow rate per unit time greater than the rate of flow into the distributing channel 301 is needed.

In the present embodiment, the flow rate C through each of the pressure compartments 113 per unit time is set to 1.5e−4 mL/min (milliliter/minute), the ejection orifice rows are arranged at a pitch of 600 dpi (dots per inch) in four rows, and the pressure compartments 113 are arranged over a span of 1.5 inches. In this case, the total CALL of the flow rate C of ink per color is CALL=4×600×1.5×1.5e−4=0.54 mL/min. In the present embodiment, when the viscosity of ink is adjusted to 5 cps (7 cP (centipoise) at room temperature 25° C. (Celsius)) by temperature control of the ejection element substrate 110, the pressure difference that makes the flow rate C of each of the pressure compartments 113 equal to 1.5e−4 mL/min is 70 [mmAq]. Substantially the same pressure difference is applied also to the bypass opening 123. In the present embodiment, the bypass openings 123 are provided at four places for four ejection orifice rows, each having a straight-duct shape with an opening diameter φ=0.1 mm and a length of 0.3 mm (millimeter). The flow rate is determined by the cross-sectional area and length of the channel and by the differential pressure. The flow rate per unit time of the ink flow (dotted arrow D) through the bypass opening 123 is Q=5.6e−2 mL/min, and the total of the flow rate D is QALL=4×4×5.6e−2=0.896 mL/min.

In the present embodiment, the ink supply capability per unit time of the circulation pump 203 may be at least CALL+QALL=1.436 mL/min, whereas it is set to 2.1 mL/min. When the flow-passage lengths of the common supply channel 111 and the common collection channel 112 are long, pressure loss occurs due to the ink flow; therefore, if the differential pressure setting is increased to cope with this, the pressure difference may be set higher than 70 [mmAq]. Moreover, the supply capability of the circulation pump 203 for maintaining the differential pressure may also be set higher in accordance with the above pressure setting.

When the ink viscosity is low (4 cps or less at 25° C.) and pressure loss in the circulation channel is small, or when the number of ejection orifices and the number of bypass openings increase, the liquid-sending capability of the circulation pump 203 (flow rate per unit time at which the pump can send the liquid) needs to be set higher. Also, under conditions in which a high nozzle circulation flow rate is used, such as when a highly volatile ink is used or as a result of temperature control settings, the liquid-sending capability of the circulation pump 203 may be set higher.

On the other hand, when the ink viscosity is high (10 cps or more at 25° C.) and the temperature control setting is low, or when there is no temperature control mechanism, the ink supply capability of the circulation pump 203 can be set lower; however, the circulation pump 203 may be suitable for high-viscosity ink.

For example, with regard to ink viscosity, inks having viscosities of 0.89 cps or more and 30 cps or less at 25° C. are sometimes employed in inkjet recording apparatuses. In such a case, the circulation pump 203 may have a configuration capable of sending such inks. As the circulation pump 203 satisfying these criteria (per color of ink), it is possible to employ an air-operated diaphragm pump in which the volume of a pump chamber serving as a pump is about 100 cm³ and the maximum sendable flow rate is 2000 mL/min or less. With such a circulation pump, adaptation to a serial-scan-type inkjet recording head is possible while accommodating the expected range of ink viscosities.

To use a liquid ejecting head in a serial-scan-type manner, it may take the size and weight of the circulation pump 203 into consideration. Therefore, it is preferable that the amount of pure water at 25° C. that the circulation pump 203 can send per unit time be 25 mL/min or less per 1 cm³ of the volume of the pump chamber. This is because, if a circulation pump having a higher efficiency than this is employed, the volume occupied by the circulation pump 203 within the liquid ejecting head exceeds 100 cm³, which reduces suitability for a serial-scan-type system.

On the other hand, in a diaphragm pump, non-return valves are provided at an inflow hole through which ink flows into the pump chamber and at an outflow hole through which ink flows out of the pump chamber; therefore, the opening and closing of these non-return valves may be performed in a stable manner. For this reason, it is preferable that the amount of pure water at 25° C. that the circulation pump 203 can send per unit time be 0.003 mL/min or more per 1 cm³ of the volume of the pump chamber. If the liquid-sending capability of the circulation pump 203 satisfies the above condition, stable opening and closing of the non-return valves will be achieved.

In view of the above constraints, the circulation pump employed in the present embodiment is a diaphragm pump having liquid-sending capability of approximately 0.7 mL/min of pure water at 25° C. per unit time. Since the sendable amount of the circulation pump is not less than the minimum sendable amount and not more than the maximum sendable amount, the size of the pump mechanism may be held down to about 3 cm³ without impairing liquid-sending characteristics. That is, even when the circulation pump 203 is mounted in the liquid ejecting head, the circulation pump 203 can be reduced in size, and the liquid ejecting head according to the present embodiment exhibits high suitability for a serial-scan-type system. Note that, in the liquid ejecting head according to the present embodiment, even when ink whose amount is more than necessary is supplied to the first pressure control chamber 211, an excess amount of ink is returned to the second pressure control chamber 221 by the second pressure regulation mechanism 202, and hence the likelihood of problem occurrence is small.

### Variation Example

Next, the configuration of a liquid ejecting head in a variation example will now be described. In the variation example, the positions of the supply openings 121, the collection openings 122, and the bypass openings 123 formed in the cover plate 151 are different from those in the first embodiment. Portions that are different from those in the first embodiment will be mainly described below, and no repetitive description will be given for portions that are the same as or similar to those in the first embodiment.

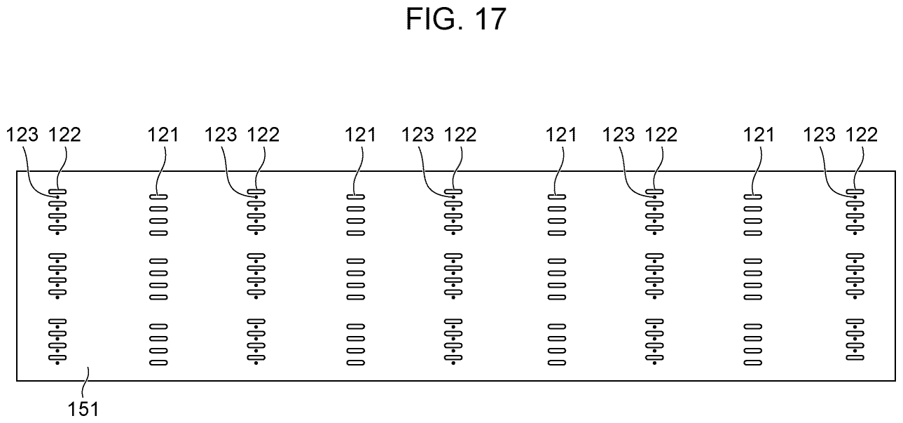

FIG. 17 is a top view of the cover plate 151 in the variation example. In the first embodiment, the supply openings 121 are provided near both end portions of the cover plate 151. The cover plate 151 in the variation example is different therefrom in that the collection openings 122 are provided near both end portions of the cover plate 151. That is, the supply openings 121 are not provided at positions including both end portions of the common supply channel 111, and the collection openings 122 are provided at positions including both end portions of the common collection channel 112. In other words, in the variation example, the positions of the supply openings 121 and the collection openings 122 are swapped in relation to those in the first embodiment. The supply openings 121 corresponding to one ejection orifice row are formed at four places, and the collection openings 122 are formed at five places.

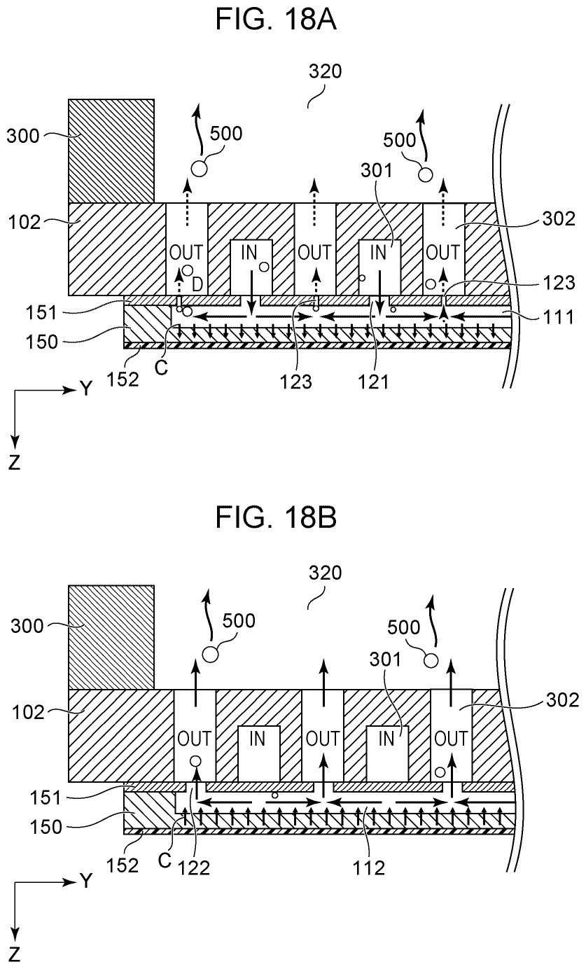

FIGS. 18A and 18B are enlarged cross-sectional views of a common channel of a liquid ejecting head. FIG. 18A illustrates the neighborhood of a common supply channel in a cross section in an enlarged manner, and FIG. 18B illustrates the neighborhood of a common collection channel in a cross section in an enlarged manner. Compared with the first embodiment, in the liquid ejecting head according to the variation example, the positions of the supply openings 121 and the collection openings 122 are swapped. Accordingly, the positions of the distributing channel 301 and the merging channel 302 are also swapped. As illustrated in FIG. 18A, in the variation example, the bypass opening 123 is formed at an end portion of the common collection channel 112. Therefore, unlike the first embodiment, the risk of air bubbles stagnating at the end portion of the common supply channel is reduced, and air bubbles throughout the common supply channel 111 are more easily collected to the merging channel 302 via the bypass openings 123. That is, the risk that air bubbles stagnating at an end portion of the common supply channel 111 might be entrained into the pressure compartments 113 is also reduced, whereby poor ejection can be suppressed.

The present disclosure provides a liquid ejecting head and a liquid ejecting apparatus that reduce the risk of an air bubble stagnating in a channel near a pressure compartment without increasing the size of the liquid ejecting head and the liquid ejecting apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-201922, filed on Nov. 19, 2024, which is hereby incorporated by reference herein in its entirety.

What is claimed is:

1. A liquid ejecting head comprising:
a plurality of ejection orifice rows each configured as an array comprised of a plurality of ejection orifices for ejecting liquid;
a plurality of pressure compartments where pressure acts on the liquid that is to be ejected from the plurality of ejection orifices;
a plurality of common supply channels extending in an array direction of the ejection orifice row and configured to supply the liquid to the plurality of pressure compartments;
a plurality of common collection channels extending in the array direction of the ejection orifice row and configured to collect the liquid from the plurality of pressure compartments;
a distributing channel configured to distribute the liquid to the plurality of common supply channels;
a merging channel configured to merge the liquid from the plurality of common collection channels;
a circulation pump configured to circulate the liquid in an order of the distributing channel, the common supply channel, the pressure compartment, the common collection channel, and the merging channel; and
a bypass opening for connection between the common supply channel and the merging channel without going through the pressure compartment.

2. The liquid ejecting head according to claim 1, comprising:
a collection opening row configured as an array comprised of a plurality of collection openings for connection between the common collection channel and the merging channel, wherein
in an array direction of the collection opening row, the bypass opening is formed between the plurality of collection openings.

3. The liquid ejecting head according to claim 1, comprising:
a supply opening row configured as an array comprised of a plurality of supply openings for connection between the common supply channel and the merging channel, wherein
in an array direction of the supply opening row, the bypass opening is formed between the plurality of supply openings.

4. The liquid ejecting head according to claim 1, wherein an opening shape of the bypass opening is elliptical.

5. The liquid ejecting head according to claim 1, comprising:
a common supply channel array comprised of the plurality of common supply channels, wherein
a length of the common supply channel in an array direction of the common supply channel array is 250 μm or less.

6. The liquid ejecting head according to claim 1, comprising:
a common collection channel array comprised of the plurality of common collection channels, wherein a length of the common collection channel in an array direction of the common collection channel array is 250 μm or less.

7. The liquid ejecting head according to claim 1, wherein
an amount of pure water at 25° C. that the circulation pump is capable of sending per unit time is 2000 mL/min or less.

8. The liquid ejecting head according to claim 1, wherein
the circulation pump includes a pump chamber configured to function as a pump, and
an amount of pure water at 25° C. that the circulation pump is capable of sending per unit time is 25 mL/min or less per 1 cm³ of a volume of the pump chamber.

9. The liquid ejecting head according to claim 1, wherein
the circulation pump includes a pump chamber configured to function as a pump, and
an amount of pure water at 25° C. that the circulation pump is capable of sending per unit time is 0.003 mL/min or more per 1 cm³ of a volume of the pump chamber.

10. The liquid ejecting head according to claim 1, wherein
a viscosity of the liquid ejected from the ejection orifice at 25° C. is 0.89 cps or more and 30 cps or less.

11. The liquid ejecting head according to claim 1, comprising:
a plurality of distributing channels each as the distributing channel, and a plurality of merging channels each as the merging channel, wherein
in the array direction of the ejection orifice row, the distributing channels and the merging channels are arranged alternately.

12. The liquid ejecting head according to claim 1, comprising:
an ejection substrate in which the plurality of ejection orifice rows, the plurality of pressure compartments, the plurality of common supply channels, and the plurality of common collection channels are formed;
a supporting substrate that supports the ejection substrate; and
a plate-shaped member interposed between the ejection substrate and the supporting substrate and forming a part of wall surfaces of the plurality of common supply channels and the plurality of common collection channels; wherein
the distributing channel and the merging channel are formed in the supporting substrate, and
the bypass opening is formed in the plate-shaped member.

13. The liquid ejecting head according to claim 12, wherein
a collection opening for connection between the merging channel and the common collection channel is formed in the plate-shaped member, and an opening diameter of the bypass opening is smaller than an opening diameter of the collection opening.

14. The liquid ejecting head according to claim 12, wherein
a supply opening for connection between the distributing channel and the common supply channel is formed in the plate-shaped member, and an opening diameter of the bypass opening is smaller than an opening diameter of the supply opening.

15. The liquid ejecting head according to claim 1, comprising:
a plurality of merging channels each as the merging channel; and
an air bubble reservoir channel connected to the plurality of merging channels, wherein
a bent portion configured to retain an air bubble is provided in the air bubble reservoir channel.

16. The liquid ejecting head according to claim 15, wherein
a first portion and a second portion are provided in the air bubble reservoir channel,
the second portion is located above the first portion in a vertical direction when the liquid ejecting head is in use, and
in a predetermined direction, a length of the second portion is greater than a length of the first portion.

17. A liquid ejecting apparatus comprising:
a liquid ejecting head; and
a carriage for mounting the liquid ejecting head thereon,
the liquid ejecting head including:
a plurality of ejection orifice rows each configured as an array comprised of a plurality of ejection orifices for ejecting liquid;
a plurality of pressure compartments where pressure acts on the liquid that is to be ejected from the plurality of ejection orifices;
a plurality of common supply channels extending in an array direction of the ejection orifice row and configured to supply the liquid to the plurality of pressure compartments;
a plurality of common collection channels extending in the array direction of the ejection orifice row and configured to collect the liquid from the plurality of pressure compartments;
a distributing channel configured to distribute the liquid to the plurality of common supply channels;
a merging channel configured to merge the liquid from the plurality of common collection channels;
a circulation pump configured to circulate the liquid in an order of the distributing channel, the common supply channel, the pressure compartment, the common collection channel, and the merging channel; and
a bypass opening for connection between the common supply channel and the merging channel without going through the pressure compartment, wherein
the carriage moves relatively in relation to a recording medium onto which the liquid is ejected from the liquid ejecting head.
